(19) United States
(12) Patent Application Publication
(10) Pub. No.: US 2026/0001182 A1
(43) Pub. Date: Jan. 1, 2026

(54) ROBOT CONTROL DEVICE, CONTROL METHOD, AND SYSTEM

(71) Applicant: FANUC CORPORATION, Yamanashi (JP)

(72) Inventor: Yuki Ishii, Yamanashi (JP)

(21) Appl. No.: 18/992,339

(22) PCT Filed: Oct. 20, 2022
(86) PCT No.: PCT/JP2022/039158

§ 371 Date: Jan. 8, 2025

(51) Int. Cl. B23Q 7/04; B25J 9/16

(52) U.S. Cl. CPC B23Q 7/04; B25J 9/1633; B25J 9/1679

(57) ABSTRACT

A control device and method for preventing machining precision from deteriorating due to foreign matter sandwiched between a workpiece and a fixing mechanism. The control device controls a robot configured to provide the workpiece to the fixing mechanism and that has a force detection unit for detecting force and moment applied to the workpiece. The control device includes a function for performing a force control to correct the position of the workpiece relative to the fixing mechanism while the robot supplies the workpiece to the fixing mechanism, and then correct the orientation of the workpiece relative to the fixing mechanism; and a function for determining that foreign matter is wedged between the workpiece and the fixing mechanism if, during correction of the position of the workpiece, the force detection unit detects that the moment acting in the direction that the orientation of the workpiece is corrected exceeds a threshold value.

### CROSS-REFERENCE TO RELATED APPLICATIONS

This application is a National Stage application of International Application No. PCT/JP2022/039158 filed on Oct. 20, 2022.

### BACKGROUND

### Field

The present invention relates to a controller and a control method for a robot, and a system.

### Discussion of the Related Art

A robot may be used as a means for supplying a workpiece to a machine such as a machine tool. For example, a technique is known in which a robot device supplies a workpiece to be processed to a chuck mechanism equipped on a machine tool (e.g., see WO 2022/0172873 A1).

Also, a technique has been proposed for detecting a foreign matter which is present between an object and a fixing device when the object is seated on the fixing device (e.g., see JP 2015-104759 A).

Further, a technique has been proposed in which two robots grip respective workpieces, and force control is used when one workpiece is fitted onto the other. (e.g., see JP 2018-024049 A).

### SUMMARY

When a workpiece held by a robot is supplied to a fixing mechanism such as a chuck of a machine tool, if foreign matter such as cutting chips or debris adheres to or is caught in the fixing mechanism or the workpiece, the workpiece may be fixed with the foreign matter caught between the workpiece and the fixing mechanism, which may result in a deterioration in the machining accuracy of the workpiece.

One aspect of the present disclosure provides a controller of a robot configured to supply a workpiece held by the robot to a fixing mechanism and having a force detection unit for detecting a force and a moment applied to the workpiece, the controller comprising: a function for executing force control in which a position of the workpiece relative to the fixing mechanism is corrected during the robot supplies the workpiece to the fixing mechanism, and then a posture of the workpiece relative to the fixing mechanism is corrected; and a function for determining that, when the force detection unit detects that the moment acting in a direction correcting the posture of the workpiece exceeds a first threshold value during the position of the workpiece is corrected, a foreign matter is caught between the workpiece and the fixing mechanism.

Another aspect of the present disclosure provides a controller of a robot configured to supply a workpiece held by the robot to a fixing mechanism and having a force detection unit for detecting a force and a moment applied to the workpiece, the controller comprising: a function for executing force control in which a position of the workpiece relative to the fixing mechanism is corrected during the robot supplies the workpiece to the fixing mechanism, and then a posture of the workpiece relative to the fixing mechanism is corrected; a function for storing the position and the posture of a first workpiece when the force control is normally executed; and a function for determining that, when the force detection unit detects that a difference between a position and a posture of a second workpiece when the force control is executed and the stored position and the stored posture of the first workpiece exceeds a second threshold value, a foreign matter is caught between the second workpiece and the fixing mechanism.

Still another aspect of the present disclosure provides a controller of a robot configured to supply a workpiece held by the robot to a fixing mechanism and having a force detection unit for detecting a force and a moment applied to the workpiece, the controller comprising: a function for executing force control in which a position of the workpiece relative to the fixing mechanism is corrected during the robot supplies the workpiece to the fixing mechanism, and then a posture of the workpiece relative to the fixing mechanism is corrected; a function for storing the position and the posture of a first workpiece when the force control is normally executed; a function for executing position control in which a position and a posture of a second workpiece are corrected so that the position and the posture of the second workpiece coincide with the stored position and the stored posture of the first workpiece; and a function for determining that, when the force detection unit detects that a force or torque applied to the second workpiece exceeds a third threshold value when the second workpiece is fixed by the fixing mechanism after the position control, a foreign matter is caught between the second workpiece and the fixing mechanism.

### BRIEF DESCRIPTION OF DRAWINGS

FIG. 1 is a schematic view of a main part of a robot system according to an embodiment.

FIG. 2 is a view showing a stated in which a posture of a workpiece is corrected.

FIG. 3 is a view showing a state in which the workpiece is fixed by a chuck.

FIG. 4 is a view showing a flowchart of a procedure in a first example.

FIG. 5 is a view showing a flowchart of a procedure in a second example.

FIG. 6 is a view showing a flowchart of a procedure in a third example.

### DESCRIPTION OF EMBODIMENTS

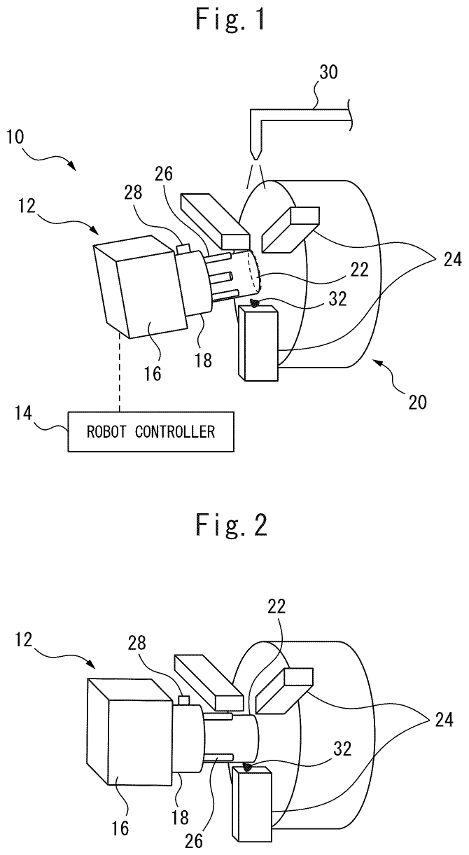

FIG. 1 is a schematic view of a main part of a robot system 10 according to a preferred embodiment. The robot system 10 includes a robot 12, and a robot controller 14 configured to control the robot 12. FIG. 1 illustrates only a movable part, i.e., a robot arm 16 and a robot hand 18 provided at a front end of the robot arm 16, among the components of the robot 12, and does not illustrate the other components. The robot 12 is, for example, an industrial vertical articulated robot having six drive axes. However, the present disclosure is not limited to this, and any robot capable of changing the position and posture by any mechanism can be used.

The robot 12 is configured to supply a workpiece 22, which is an object to be processed, to a machine tool 20, and only a workpiece fixing mechanism (e.g., a chuck) 24 of the machine tool 20 is shown in FIG. 1. The robot hand 18 has a gripping mechanism 26 for gripping the workpiece 22, and in the illustrated example, has a plurality of gripping fingers capable of gripping the substantially cylindrical workpiece 22. The hand 18 also has a force detection unit 28 configured to detect the force, bending moment, distortion, etc., applied to the gripping mechanism 26 or the workpiece 22 gripped by the gripping mechanism 26. For example, a three-axis or six-axis force sensor configured to detect at least one of an external force and moment applied to the workpiece 22 can be used as the force detection unit 28. However, the force detection unit is not limited to this, and for example, a torque sensor (not shown) provided on each axis of the robot 12, or a means (not shown) for estimating the torque based on a current value of a motor provided on each axis of the robot 12 may be used as the force detection unit.

The machine tool 20 is configured to perform predetermined machining such as cutting on the workpiece 22 fixed to the chuck 24. The machine tool 20 may include a cleaning device such as a nozzle 30 configured to spray fluid such as compressed air or a coolant toward the chuck 24 to remove foreign matter such as cutting chips adhered to the chuck 24 or the workpiece 22 fixed to the chuck 24. However, a cleaning device such as a nozzle having a function equivalent to that of the nozzle 30 may also be provided on the robot 12, or on another robot or peripheral equipment (not shown). In either case, the cleaning device can spray fluid to clean the chuck 24 based on a command output by the robot controller 14 in a process described below.

In the robot system 10 which supplies the workpiece 22 to the machine tool 20, foreign matter 32 such as cutting chips may adhere to the chuck 24 as shown in FIG. 1. When the workpiece 22 is fixed to the chuck 24 in such a state, the foreign matter 32 may be caught between the workpiece 22 and the chuck 24, causing the center of the workpiece 22 to shift relative to the chuck 24, which may result in a decrease in machining accuracy. Even when no foreign matter is adhered to the chuck 24, foreign matter such as workpiece fragments resulting from previous machining may adhere to the workpiece 22 held by the robot 12, and in such a case, the same problem may occur. Therefore, in the following examples, means and process for detecting the presence of such foreign matter will be described.

In the embodiment, the term “foreign matter” refers to an object which may be caught between the workpiece 22 and the chuck 24, thereby reducing the positioning accuracy of the workpiece relative to the fixing mechanism and thus reducing the machining accuracy. For example, the foreign matter may include chips and debris generated by machining of the workpiece, a hair of an operator, and dust in some working environments. Examples of the chips may include those generated during machining of a previous workpiece and adhered to the chuck, and examples of the debris may include those that remain adhered to the workpiece during previous machining.

FIG. 4 is a flowchart showing an example of a process according to a first example in the robot system 10. First, force control is executed to make the position and posture of the workpiece 22 held by the robot 12 appropriate with respect to the chuck 24 of the machine tool 20. In this case, as shown in FIG. 2, the posture of the workpiece 22 is first corrected by pressing the workpiece 22 against a spindle or the chuck 24 of the machine tool 20, and then the position of the workpiece 22 is corrected by following the chuck 24 when the chuck 24 closes (steps S11 and S12).

Next, in step S12, i.e., when correcting the position of the workpiece 22, it is determined whether or not the force detection unit 28 detects a moment (hereinafter, referred to as the posture correction moment) acting in a direction correcting the posture of the workpiece 22. When there is no foreign matter between the workpiece 22 and the chuck 24, no posture correction moment is generated when correcting the position. On the other hand, when there is the foreign matter 32 as shown in FIG. 1, a significant posture correction moment is generated when correcting the position. Therefore, when the force detection unit 28 detects a posture correction moment equal to or greater than a predetermined threshold, it can be determined that a foreign matter is present, and thus it is desirable to interrupt the supply operation of the workpiece 22 by the robot 12 and proceed to step S14 to remove the foreign matter.

As a specific process of step S13, when the posture correction moment detected by the force detection unit 28 during the position correction (the execution of step S12) exceeds a predetermined first threshold value, a processor, etc., of the robot controller 14 determines that the foreign matter is present between the workpiece 22 and the chuck 24. In this regard, the first threshold value can be determined, for example, as a maximum value within a range which does not affect the machining accuracy of the workpiece 22, and can be empirically determined, for example, based on past performance. In other words, even when the posture correction moment equal to or less than the first threshold value is detected, the caught foreign matter is extremely small and is considered not to affect the machining accuracy, so that the process proceeds to step S15 and the machining of the workpiece 22 can be continued.

In step S14, coolant or air is sprayed from the nozzle 30 toward the fixing mechanism (here, the chuck 24) to clean the chuck 24 (or remove the foreign matter 32). This operation can be performed automatically based on a command from the robot controller 14. Alternatively or in addition to this, the robot controller 14, etc., may have a function of outputting an alarm. By outputting the alarm, the operator, etc., who recognizes the alarm can manually clean the chuck 24.

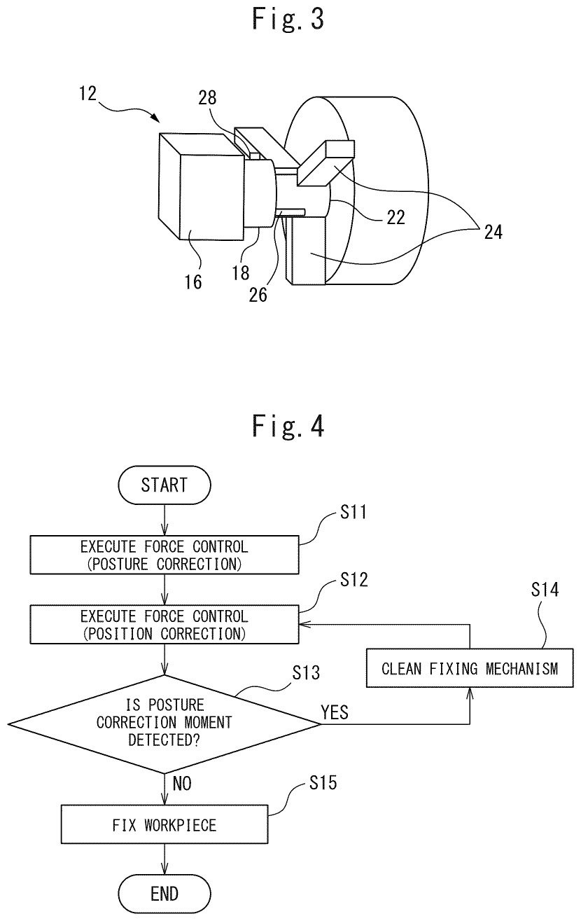

When cleaning of the chuck 24 (removal of the foreign matter 32) is completed in S14 and the posture correction moment is no longer detected, the workpiece 22 is fixed by the chuck 24 as shown in FIG. 3. Due to this, the machine tool 20 can machine the workpiece 22 with high accuracy.

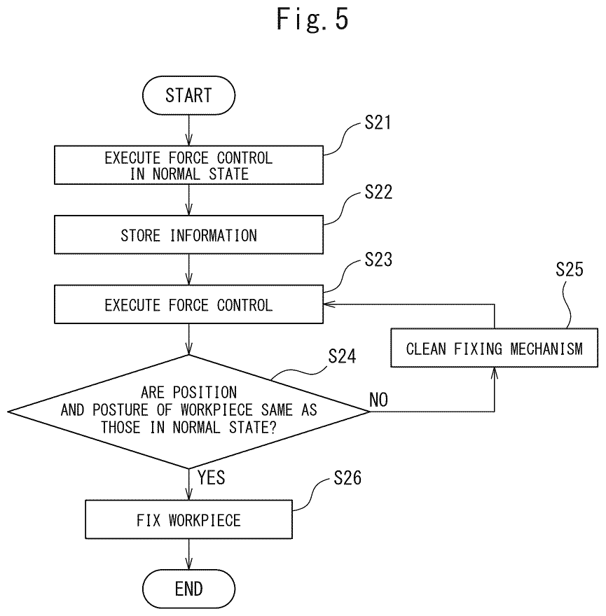

FIG. 5 is a flowchart showing an example of a process according to a second example in the robot system 10. First, in a state in which it is confirmed that no foreign matter is present between a first workpiece and the chuck 24 (hereinafter, also referred to as a normal state), force control substantially equivalent to steps S11 and S12 described in the first example is executed for the first workpiece (step S21). Then, when the force control is completed (i.e., when the first workpiece is accurately positioned with the correct posture relative to the chuck 24), information regarding the position and posture of the first workpiece (position data and posture data, etc.) is stored in an appropriate storage device (e.g., a memory included in the robot controller 14) (step S22).

Next, in step S23, under a state different from the normal state (specifically, when a workpiece different from the normal state is supplied to the chuck 24 in which the presence of foreign matter is unknown), force control substantially equivalent to steps S11 and S12 described in the first example is executed on a second workpiece different from the first workpiece.

In the next step S24, information regarding the position and posture of the second workpiece when the force control in step S23 is completed is compared with the stored information in the normal state. More specifically, when the respective differences between the values representing the position and posture of the second workpiece in step S23 and the stored values representing the position and posture of the first workpiece in the normal state are within a predetermined second threshold value, the position and posture of the second workpiece at the time of execution of step S23 is substantially equivalent to that in the normal state, and then the processor, etc., of the robot controller 14 can determine that no foreign matter exists between the second workpiece and the chuck 24. Therefore, the process proceeds to step S26, where the second workpiece is fixed by the chuck 24 as shown in FIG. 3, and a predetermined machining process is performed. The second threshold value can be set as the difference in the position and the difference in the posture of the workpiece as described above, and can be determined as the maximum value in a range which does not affect the machining accuracy of the workpiece, as in the first example, and can be empirically determined, for example, based on past performance. In other words, when the difference in position or posture between when S23 is executed and the normal state is equal to or less than the second threshold value, even when the foreign matter is caught, it is considered that the machining accuracy will not be affected, so that the process can proceed to step S26 to continue the machining the workpiece. The second threshold value may be set as a ratio of the position or posture between when S23 is executed and the normal state. For example, the ratio of the position or posture when S23 is executed to the position or posture in the normal state can be set a value within ±5% or ±3%.

When at least one of the position and posture of the workpiece in step S23 is significantly different from that in the normal state, it can be determined that a foreign matter is present between the second workpiece and the chuck 24, so it is desirable to interrupt the supply operation of the second workpiece by the robot 12 and proceed to step S25 to remove the foreign matter. The content of step S25 may be substantially the same as step S14 in the first example.

When cleaning of the chuck 24 (or removal of the foreign matter 32) is completed in S25 and the position and posture of the second workpiece during the execution of the force control become substantially the same as those during the normal state, the second workpiece is fixed by the chuck 24 as shown in FIG. 3. Due to this, the machine tool 20 can machine the workpiece 22 with high accuracy.

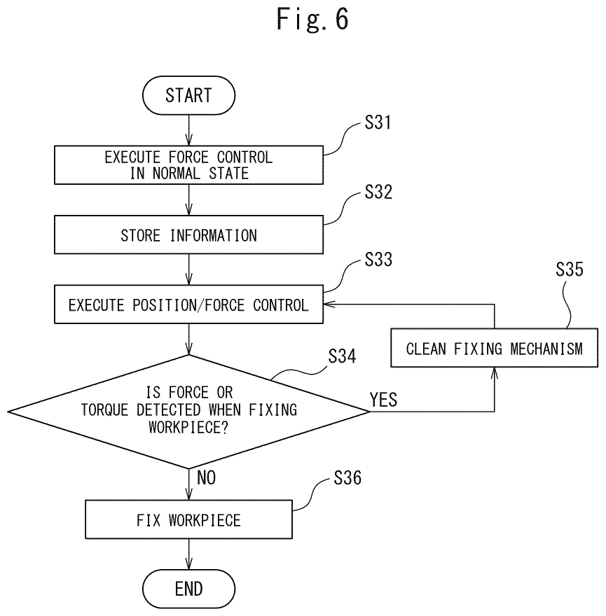

FIG. 6 is a flowchart showing an example of a process according to a third example in the robot system 10. First, in a state in which it is confirmed that no foreign matter is present between the first workpiece and the chuck 24 (hereinafter, also referred to as a normal state), force control substantially equivalent to steps S11 and S12 described in the first example is executed for a first workpiece (step S31). Then, when the force control is completed (i.e., when the first workpiece is accurately positioned with the correct posture relative to the chuck 24), information regarding the position and posture of the first workpiece (position data and posture data, etc.) is stored in an appropriate storage device (e.g., a memory included in the robot controller 14) (step S32).

In the next step S33, the position and posture of a second workpiece are controlled based on the information stored in step S32 under a state different from the normal state (specifically, when a second workpiece different from the normal state is supplied to the chuck 24 in which the presence of foreign matter is unknown). This control differs from the force control in the first or second example, and is position control for changing the position and posture of the second workpiece so that they coincide with the final position and posture of the first workpiece in step S31.

In the next step S34, the chuck 24 is closed, and at that time, it is detected whether or not a force or torque has been applied to the second workpiece or the hand 18. In other words, when there is no foreign matter between the second workpiece and the chuck 24, no force or torque will be applied to the second workpiece when the chuck is closed. On the other hand, when there is foreign matter, force or torque of a certain level or more will be applied. Therefore, when no force or torque is detected, the process proceeds to step S36, and the operation of fixing the second workpiece with the chuck 24 is completed as shown in FIG. 3.

As a specific process of step S34, when the force detection unit 28 detects a force or torque equal to or greater than a predetermined third threshold value during the chuck 24 is gripping the second workpiece after the execution of S33, the processor of the robot controller 14 determines that the foreign matter is present between the second workpiece and the chuck 24. In this regard, the third threshold value can be determined as a maximum value within a range which does not affect the machining accuracy of the workpiece, as in the first or second example, and can be empirically determined based on, for example, past performance. In other words, when the maximum value of the force or torque detected during the workpiece is fixed by the chuck 24 after the execution of S33 is equal to or less than the third threshold value, it is considered that, even when the foreign object is caught, the machining accuracy will not be affected, so the process proceeds to step S36 and the machining of the workpiece can be continued.

When a force or torque equal to or greater than the third threshold value is detected in step S34, it can be determined that a foreign matter is present between the workpiece 22 and the chuck 24, and thus it is desirable to interrupt the supply operation of the workpiece 22 by the robot 12, proceed to step S35, and perform an operation to remove the foreign matter. The content of step S35 may be substantially the same as step S14 in the first example.

When cleaning of the chuck 24 (or removal of the foreign matter 32) is completed in S35 and the position and posture of the second workpiece during the execution of the position control become substantially the same as those in the normal state, the second workpiece is fixed by the chuck 24 as shown in FIG. 3. Due to this, the machine tool 20 can machine the workpiece 22 with high accuracy.

The above-mentioned functions of the controller 14 can also be provided by a computer program executable by the processor of the controller 14. The controller 14 can also include a storage device such as a memory configured to store data used in each process and data generated by each process. The computer program may be provided by being recorded on a non-transitory computer-readable recording medium such as a semiconductor memory, a magnetic recording medium, or an optical recording medium, for example, a CD-ROM, or may be provided by being distributed from a server device on a WAN (wide area network) or LAN (local area network) via a wired or wireless connection.

According to the above-described examples, the presence of foreign matter between the workpiece supplied by the robot and the workpiece fixing mechanism can be detected by a simple process, thereby preventing deterioration of the machining accuracy of the workpiece due to the caught foreign matter.

Although the present disclosure has been described in detail, the present disclosure is not limited to the above-mentioned individual embodiments. Various additions, replacements, modifications, partial deletions, etc. are possible for these embodiments within the scope of the gist of the present disclosure, or within the scope of the gist of the present disclosure derived from the contents described in the claims and their equivalents. These embodiments can also be implemented in combination. For example, in the above-mentioned embodiments, the order of each operation and the order of each process are shown as examples, and are not limited to these. The same applies when numerical values or formulas are used in the description of the above-mentioned embodiments.

The following supplementary clauses are further disclosed regarding the above-described embodiment and modified examples.

### Clause 1

A controller of a robot configured to supply a workpiece held by the robot to a fixing mechanism and having a force detection unit for detecting a force and a moment applied to the workpiece, the controller comprising: a function for executing force control in which a position of the workpiece relative to the fixing mechanism is corrected during the robot supplies the workpiece to the fixing mechanism, and then a posture of the workpiece relative to the fixing mechanism is corrected; and a function for determining that, when the force detection unit detects that the moment acting in a direction correcting the posture of the workpiece exceeds a first threshold value during the position of the workpiece is corrected, a foreign matter is caught between the workpiece and the fixing mechanism.

### Clause 2

A controller of a robot configured to supply a workpiece held by the robot to a fixing mechanism and having a force detection unit for detecting a force and a moment applied to the workpiece, the controller comprising: a function for executing force control in which a position of the workpiece relative to the fixing mechanism is corrected during the robot supplies the workpiece to the fixing mechanism, and then a posture of the workpiece relative to the fixing mechanism is corrected; a function for storing the position and the posture of a first workpiece when the force control is normally executed; and a function for determining that, when the force detection unit detects that a difference between a position and a posture of a second workpiece when the force control is executed and the stored position and the stored posture of the first workpiece exceeds a second threshold value, a foreign matter is caught between the second workpiece and the fixing mechanism.

### Clause 3

A controller of a robot configured to supply a workpiece held by the robot to a fixing mechanism and having a force detection unit for detecting a force and a moment applied to the workpiece, the controller comprising: a function for executing force control in which a position of the workpiece relative to the fixing mechanism is corrected during the robot supplies the workpiece to the fixing mechanism, and then a posture of the workpiece relative to the fixing mechanism is corrected; a function for storing the position and the posture of a first workpiece when the force control is normally executed; a function for executing position control in which a position and a posture of a second workpiece are corrected so that the position and the posture of the second workpiece coincide with the stored position and the stored posture of the first workpiece; and a function for determining that, when the force detection unit detects that a force or torque applied to the second workpiece exceeds a third threshold value when the second workpiece is fixed by the fixing mechanism after the position control, a foreign matter is caught between the second workpiece and the fixing mechanism.

### Clause 4

The controller according to any one of clauses 1 to 3, further comprising a function for outputting a command for cleaning the fixing mechanism when it is judged that the foreign matter is caught.

### Clause 5

The controller according to any one of clauses 1 to 4, further comprising a function for outputting an alarm when the controller judges that the foreign matter is caught.

### Clause 6

A robot system comprising the controller according to any one of clauses 1 to 5, and a robot controlled by the controller.

### Clause 7

The robot system according to clause 6, further comprising a cleaning device configured to clean the fixing mechanism when it is judged that the foreign matter is caught.

### Clause 8

A control method of a robot configured to supply a workpiece held by the robot to a fixing mechanism and having a force detection unit for detecting a force and a moment applied to the workpiece, the control method comprising: executing force control in which a position of the workpiece relative to the fixing mechanism is corrected during the robot supplies the workpiece to the fixing mechanism, and then a posture of the workpiece relative to the fixing mechanism is corrected; and judging that, when the force detection unit detects that the moment acting in a direction correcting the posture of the workpiece exceeds a first threshold value during the position of the workpiece is corrected, a foreign matter is caught between the workpiece and the fixing mechanism.

### Clause 9

A control method of a robot configured to supply a workpiece held by the robot to a fixing mechanism and having a force detection unit for detecting a force and a moment applied to the workpiece, the control method comprising: executing force control in which a position of the workpiece relative to the fixing mechanism is corrected during the robot supplies the workpiece to the fixing mechanism, and then a posture of the workpiece relative to the fixing mechanism is corrected; storing the position and the posture of a first workpiece when the force control is normally executed; and judging that, when the force detection unit detects that a difference between a position and a posture of a second workpiece when the force control is executed and the stored position and the stored posture of the first workpiece exceeds a second threshold value, a foreign matter is caught between the second workpiece and the fixing mechanism.

### Clause 10

A control method of a robot configured to supply a workpiece held by the robot to a fixing mechanism and having a force detection unit for detecting a force and a moment applied to the workpiece, the control method comprising: executing force control in which a position of the workpiece relative to the fixing mechanism is corrected during the robot supplies the workpiece to the fixing mechanism, and then a posture of the workpiece relative to the fixing mechanism is corrected; storing the position and the posture of a first workpiece when the force control is normally executed; executing position control in which a position and a posture of a second workpiece are corrected so that the position and the posture of the second workpiece coincide with the stored position and the stored posture of the first workpiece; and judging that, when the force detection unit detects that a force or torque applied to the second workpiece exceeds a third threshold value when the second workpiece is fixed by the fixing mechanism after the position control, a foreign matter is caught between the second workpiece and the fixing mechanism.

### REFERENCE SIGNS LIST

10 robot system
12 robot
14 robot controller
16 robot arm
18 robot hand
20 machine tool
22 workpiece
24 chuck
26 gripping finger
28 force detection unit
30 nozzle
32 foreign matter

1. A controller of a robot configured to supply a workpiece held by the robot to a fixing mechanism and having a force detection unit for detecting a force and a moment applied to the workpiece, the controller comprising:
a function for executing force control in which a posture of the workpiece relative to the fixing mechanism is corrected during the robot supplies the workpiece to the fixing mechanism, and then a position of the workpiece relative to the fixing mechanism is corrected; and
a function for determining that, when the force detection unit detects that the moment acting in a direction correcting the posture of the workpiece exceeds a first threshold value during the position of the workpiece is corrected, a foreign matter is caught between the workpiece and the fixing mechanism.

2. A controller of a robot configured to supply a workpiece held by the robot to a fixing mechanism and having a force detection unit for detecting a force and a moment applied to the workpiece, the controller comprising:
a function for executing force control in which a posture of the workpiece relative to the fixing mechanism is corrected during the robot supplies the workpiece to the fixing mechanism, and then a position of the workpiece relative to the fixing mechanism is corrected;
a function for storing the position and the posture of a first workpiece when the force control is normally executed; and
a function for determining that, when the controller detects that a difference between a position and a posture of a second workpiece when the force control is executed and the stored position and the stored posture of the first workpiece exceeds a second threshold value, a foreign matter is caught between the second workpiece and the fixing mechanism.

3. A controller of a robot configured to supply a workpiece held by the robot to a fixing mechanism and having a force detection unit for detecting a force and a moment applied to the workpiece, the controller comprising:
a function for executing force control in which a posture of the workpiece relative to the fixing mechanism is corrected during the robot supplies the workpiece to the fixing mechanism, and then a position of the workpiece relative to the fixing mechanism is corrected;
a function for storing the position and the posture of a first workpiece when the force control is normally executed;
a function for executing position control in which a position and a posture of a second workpiece are corrected so that the position and the posture of the second workpiece coincide with the stored position and the stored posture of the first workpiece; and
a function for determining that, when the force detection unit detects that a force or torque applied to the second workpiece exceeds a third threshold value when the second workpiece is fixed by the fixing mechanism after the position control, a foreign matter is caught between the second workpiece and the fixing mechanism.

4. The controller according to claim 1, further comprising a function for outputting a command for cleaning the fixing mechanism when it is judged that the foreign matter is caught.

5. The controller according to claim 1, further comprising a function for outputting an alarm when it is judged that the foreign matter is caught.

6. A robot system comprising the controller according to claim 1, and a robot controlled by the controller.

7. The robot system according to claim 6, further comprising a cleaning device configured to clean the fixing mechanism when it is judged that the foreign matter is caught.

8. A control method of a robot configured to supply a workpiece held by the robot to a fixing mechanism and having a force detection unit for detecting a force and a moment applied to the workpiece, the control method comprising:
executing force control in which a posture of the workpiece relative to the fixing mechanism is corrected during the robot supplies the workpiece to the fixing mechanism, and then a position of the workpiece relative to the fixing mechanism is corrected; and
judging that, when the force detection unit detects that the moment acting in a direction correcting the posture of the workpiece exceeds a first threshold value during the position of the workpiece is corrected, a foreign matter is caught between the workpiece and the fixing mechanism.

9. A control method of a robot configured to supply a workpiece held by the robot to a fixing mechanism and having a force detection unit for detecting a force and a moment applied to the workpiece, the control method comprising:
executing force control in which a posture of the workpiece relative to the fixing mechanism is corrected during the robot supplies the workpiece to the fixing mechanism, and then a position posture of the workpiece relative to the fixing mechanism is corrected;
storing the position and the posture of a first workpiece when the force control is normally executed; and
judging that, when a controller for the robot detects that a difference between a position and a posture of a second workpiece when the force control is executed and the stored position and the stored posture of the first workpiece exceeds a second threshold value, a foreign matter is caught between the second workpiece and the fixing mechanism.

10. A control method of a robot configured to supply a workpiece held by the robot to a fixing mechanism and having a force detection unit for detecting a force and a moment applied to the workpiece, the control method comprising:
executing force control in which a posture of the workpiece relative to the fixing mechanism is corrected during the robot supplies the workpiece to the fixing mechanism, and then a position of the workpiece relative to the fixing mechanism is corrected;
storing the position and the posture of a first workpiece when the force control is normally executed;
executing position control in which a position and a posture of a second workpiece are corrected so that the position and the posture of the second workpiece coincide with the stored position and the stored posture of the first workpiece; and
judging that, when the force detection unit detects that a force or torque applied to the second workpiece exceeds a third threshold value when the second workpiece is fixed by the fixing mechanism after the position control, a foreign matter is caught between the second workpiece and the fixing mechanism.
